(19) United States
(12) Patent Application Publication
(10) Pub. No.: US 2024/0360574 A1
(43) Pub. Date: Oct. 31, 2024

(54) WATER ELECTROLYSIS CATALYST

(71) Applicant: UOP LLC, Des Plaines, IL (US)

(72) Inventors: Zhanyong Li, Schaumburg, IL (US); Chunqing Liu, Arlington Heights, IL (US); Stacey Deptuch, Northfield, IL (US); Saad Intikhab, Des Plaines, IL (US)

(21) Appl. No.: 18/306,609

(22) Filed: Apr. 25, 2023

(51) Int. Cl. C25B 11/073; C25B 1/04; C25B 11/052

(52) U.S. Cl. CPC C25B 11/073; C25B 1/04; C25B 11/052

(57) ABSTRACT

A family of catalysts for oxygen evolution reaction (OER) in alkaline condition is disclosed. The catalysts utilize elements which are abundant on earth, leading to lower costs compared to IrO₂ catalysts. The catalysts can be used in the anode of an anion exchange membrane-based water electrolyzer. The family of new catalysts comprises Ni, Fe, M, B, and O, where M is a metal from Group VIB, Group VIII, and elements 57-71 of the Periodic Table. The catalyst has a layered double hydroxide structure. Methods of making the catalysts are also described.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction: 2H₂O→2H₂+O₂ (1)

Oxidation reaction at anode for PEMWE: 2H₂O→O₂+4H⁺+4e⁻ (2)

Reduction reaction at cathode for PEMWE: 2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

Reduction reaction at cathode for AEMWE: 4H₂O+4e⁻→2H₂+4OH⁻ (4)

Oxidation reaction at anode for AEMWE: 4OH⁻→2H₂O+O₂+4e⁻ (5)

IrO₂ is widely accepted as the most efficient oxygen evolution reaction (OER) catalyst in PEM-WE due to its high activity and stability. However, its limited supply and high price limits its use.

Therefore, there is a need for a lower cost OER catalyst and for methods of making the catalyst.

### BRIEF DESCRIPTION OF THE DRAWINGS

FIG. 1 is an illustration of a PEMWE system.

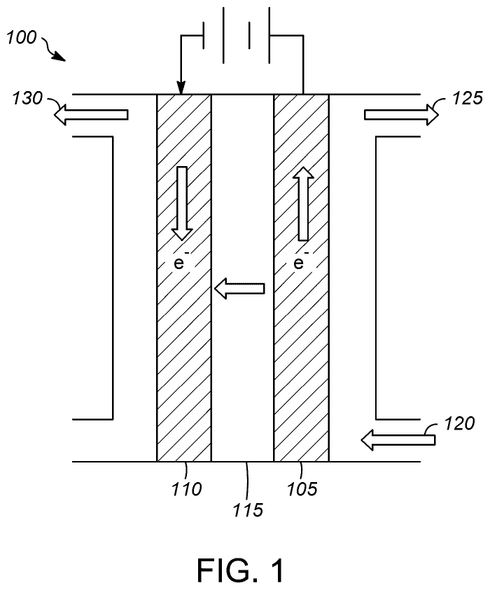

FIG. 2 is an illustration of an AEMWE system.

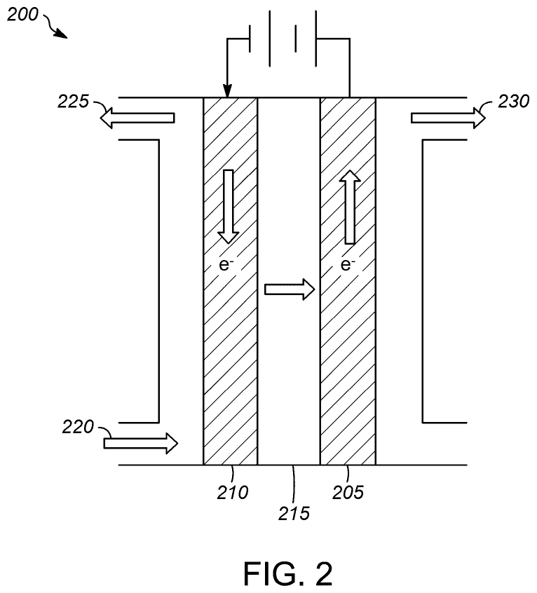

FIG. 3A-B shows the scanning transmission electron microscopy (STEM) images of the NiFeWBOₓ-Oleylamine catalyst described in Example 1 at different scales.

FIG. 3C-D shows the scanning transmission electron microscopy (STEM) images of the NiFeWBOₓ-PVP catalyst described in Example 2 at different scales.

FIG. 4 is the graph showing the comparison of oxygen evolution reaction (OER) activity of (a) NiFeWBOₓ-Oleylamine according to the Example 1 in the present invention; and (b) NiFeWBOₓ-PVP according to the Example 2 in the present invention, and (c) a commercial IrO₂ catalyst.

FIG. 5 is a graph showing the polarization curves of a water electrolysis cell comprising (a) NiFeWBOₓ-Oleylamine, (b) NiFeWBOₓ-PVP made according to the present invention, and (c) a commercial IrO₂ catalyst.

### DESCRIPTION

A family of catalysts for oxygen evolution reaction (OER) in alkaline condition is disclosed. The catalysts utilize elements which are abundant on earth, leading to lower costs compared to the expensive IrO₂ used in the anode of a PEM-WE. The catalysts can be used in the anode of an anion exchange membrane-based water electrolyzer.

The family of new catalysts comprises Ni, Fe, M, B, and O, where M is a metal from Group VIB, Group VIII, and elements 57-71 of the Periodic Table. The catalyst has a layered double hydroxide structure.

NiFe-based OER catalysts are known for OER in alkaline conditions. However, the presence of B and M in the catalyst makes it unique. The use of B makes the layered double hydroxide (LDH) material more amorphous, which is advantageous for generating more active OER sites. The use of the metal M generates more oxygen vacancy sites, which also leads to more OER active sites.

These new catalysts NiₐFeM_{b}B_{c}O_{d}(OH)ₑ(H₂O)_{f} outperform the commercial IrO₂ catalyst in alkaline conditions. The AEM water electrolysis test also indicated its superior performance in terms of activity and stability compared to IrO₂. The synthesis is straightforward and scalable. In addition, the raw material cost for the synthesis is much lower (e.g., less than $10/g) compared to Ir-based catalysts (e.g., more than $250/g).

One aspect of the invention is a non-platinum group metal (non-PGM) catalyst for oxygen evolution reaction (OER) for water electrolysis. In one embodiment, the catalyst comprises: Ni—Fe-M-B oxyhydroxide. The catalyst has a layered double hydroxide structure.

M is a metal from Group VIB, Group VIII, and elements 57-71 of the Periodic Table, or combinations thereof. Group VIB metals include, but are not limited to, Cr, Mo, and W. Group VIII metals include, but are not limited to, Co. Elements 57-71 are the Lanthanide series elements, i.e., La, Ce, Pr, Nd, Pm, Sm, Eu, Gd, Tb, Dy, Ho, Er, Tm, Yb, and Lu. In some embodiments, M comprises W, Mo, Co, Ce, or combinations thereof.

In some embodiments, the catalyst has a formula:

NiₐFeM_{b}B_{c}O_{d}(OH)ₑ(H₂O)_{f}

where a is in a range of 0.2 to 16; b is in a range of 0.01 to 6; c is in a range of 0.01 to 10; d is in a range of 0.01 to 30; e is in a range of 0.01 to 30; and f is in a range of 0.01 to 15. The oxygen and hydroxide groups are in the crystal lattice in the layered double hydroxide structure, and they balance the charge to maintain the charge neutrality of the material. The physiosorbed water molecules in the material are present in between the layers of the crystal lattice and can be removed without changing the LDH structure of the materials.

In some embodiments, the catalyst has a formula:

NiₐFeM_{b}B_{c}O_{d}(OH)ₑ(H₂O)_{f}

where a is in a range of 0.5 to 8; b is in a range of 0.01 to 3; c is in a range of 0.01 to 6; d is in a range of 0.01 to 20; e is in a range of 0.01 to 20; and f is in a range of 0.01 to 10.

In some embodiments, the catalyst comprises 10 to 60% mol Ni, or 10 to 55%, or 10 to 50%, or 10 to 45%, or 10 to 40%, or 15 to 60%, or 15 to 55%, or 15 to 50%, or 15 to 45%, or 15 to 40%, or 20 to 60%, or 20 to 55%, or 20 to 50%, or 20 to 45%, or 20 to 40%, or 25 to 60%, or 25 to 55%, or 25 to 50%, or 25 to 45%, or 25 to 40% or 30 to 60%, or 30 to 55%, or 30 to 50%, or 30 to 45%, or 30 to 40%.

In some embodiments, the catalyst comprises 5 to 40% mol Fe, or 5 to 35%, or 5 to 30%, or 10 to 40%, or 10 to 35%, or 10 to 30%, or 15 to 40%, or 15 to 35%, or 15 to 30%, or 20 to 40%, or 20 to 35%, or 20 to 30%.

In some embodiments, the catalyst comprises 0.01 to 30% mol M, or 0.01 to 25%, or 0.01 to 20%, or 0.01 to 15%, or 0.01 to 10%, or 0.01 to 5%, or 0.05 to 30%, or 0.05 to 25%, or 0.05 to 20%, or 0.05 to 15%, or 0.05 to 10%, or 0.05 to 5%, or 0.1 to 30%, or 0.1 to 25%, or 0.1 to 20%, or 0.1 to 15%, or 0.1 to 10%, or 0.1 to 5%, or 1 to 30%, or 1 to 25%, or 1 to 20%, or 1 to 15%, or 1 to 10%, or 1 to 5%.

In some embodiments, the catalyst comprises 0.01 to 40% mol B, or 0.01 to 35%, or 0.01 to 30%, or 0.01 to 25%, or 0.01 to 20%, or 0.01 to 15%, or 0.01 to 10%, or 0.01 to 5%, or 0.05 to 40%, or 0.05 to 35%, or 0.05 to 30%, or 0.05 to 25%, or 0.05 to 20%, or 0.05 to 15%, or 0.05 to 10%, or 0.05 to 5%, or 0.1 to 40%, or 0.1 to 35%, or 0.1 to 30%, or 0.1 to 25%, or 0.1 to 20%, or 0.1 to 15%, or 0.1 to 10%, or 0.1 to 5%, or 1 to 40%, or 1 to 35%, or 1 to 30%, or 1 to 25%, or 1 to 20%, or 1 to 15%, or 1 to 10%, or 1 to 5%.

In some embodiments, the catalyst comprises: 10 to 60% mol Ni; 5 to 40% mol Fe; 0.01 to 30% mol M; and 0.01 to 40% mol B.

In some embodiments, the catalyst comprises: 15 to 40% mol Ni; 5 to 30% mol Fe; 0.01 to 15% mol M; and 0.01 to 40% mol B.

In some embodiments, the catalyst comprises: 15 to 40% mol Ni; 5 to 30% mol Fe; 0.01 to 5% mol M; and 0.01 to 40% mol B.

In some embodiments, the catalyst comprises: 10 to 60% mol Ni; 5 to 40% mol Fe; 0.01 to 30% mol W, Mo, Co, Ce, or combinations thereof; and 0.01 to 40% mol B.

In some embodiments, the catalyst has a BET surface area greater than 50 m²/g, or greater than 100 m²/g, or greater than 130 m²/g, or up to 500 m²/g, or in a range of 50 to 500 m²/g, or 50 to 400 m²/g, or 50 to 300 m²/g, or 50 to 200 m²/g, or 50 to 150 m²/g, or 75 to 500 m²/g, or 75 to 400 m²/g, or 75 to 300 m²/g, or 75 to 200 m²/g, or 75 to 150 m²/g, or 100 to 500 m²/g, or 100 to 400 m²/g, or 100 to 300 m²/g, or 100 to 200 m²/g, or 100 to 150 m²/g, or 130 to 500 m²/g, or 130 to 400 m²/g, or 130 to 300 m²/g, or 130 to 200 m²/g, or 130 to 150 m²/g.

In some embodiments, the catalyst has a layered structure with a catalyst layer thickness of 200 nm or less, or 100 nm or less, or 50 nm or less.

In some embodiments, the catalyst has a BET surface area of higher than 50 m²/g and a layered structure with a catalyst layer thickness of 200 nm or less.

In some embodiments, the catalyst has a BET surface area of higher than 100 m²/g and a layered structure with a catalyst layer thickness of 100 nm or less.

In some embodiments, the catalyst has a BET surface area of higher than 130 m²/g and a layered structure with a catalyst layer thickness of 50 nm or less.

In some embodiments, the catalyst is insoluble in water or alkaline aqueous solution with a pH of 7.5 or higher. As a result, the catalyst is very stable in an AEM water electrolyzer.

In some embodiments, the catalyst is coated on one surface of an anion exchange membrane or on one surface of a porous transport material.

Another aspect of the invention is a method of making a non-platinum group metal (non-PGM) catalyst for oxygen evolution reaction (OER) for water electrolysis. In one embodiment, the method comprises: mixing a Ni precursor, an Fe precursor, and a M precursor in a solvent or solvent mixture; adding an exfoliating reagent; adding NaBH₄; heating the mixture; and precipitating and washing the catalyst; wherein M is a metal from Groups VIB or VIII, or elements 57-71 of the Periodic Table; and wherein the catalyst has a layered double hydroxide structure, as discussed above.

The composition of the catalyst, BET surface area, and layer thickness are as described above.

In some embodiments, the exfoliating reagent comprises butylamine, trimethylamine, triethanolamine, triphenylphosphine, oleylamine, polyvinylpyrrolidone, or combinations thereof.

In some embodiments, the solvent comprises water, alcohol, acetonitrile, N, N-dimethylformamide, or combinations thereof.

### EXAMPLES

### Example 1: Synthesis of NiFeWBOₓ-Oleylamine Oxygen Evolution Reaction (OER) Catalyst

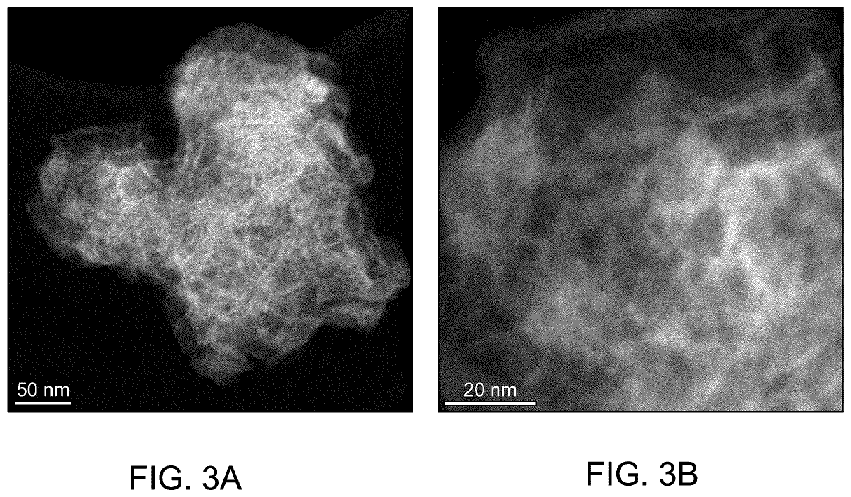

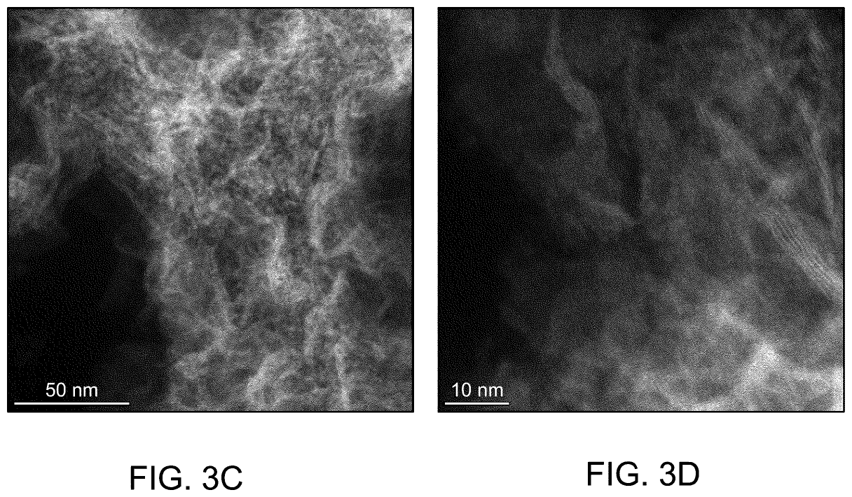

11.6261 g of nickel (II) nitrate, 4.0012 g of iron (III) nitrate and 2.2479 g of tungstic acid were added into 320 mL of a mixture of water to ethanol (v:v=1:1) solution. Subsequently, an aliquot of 1.5 mL oleylamine (C₁₈H₃₅NH₂ 70%, technical grade) was added to this solution and mixed. Afterwards, a 240 mL of solution (water to ethanol (v:v=1:1)) containing 5.0026 g of NaBH₄ was added to the solution containing the metal precursors under vigorous stirring where the formation of a black precipitate was observed. The reaction mixture was stirred for two hours at 80° C. where the color slowly changed to yellow. The final material was washed with water numerous times and freeze dried. The chemical composition of the NiFeWBOₓ-Oleylamine OER catalyst was determined to be Ni₄FeW_{0.24}B_{1.87}Oₓ via Inductively Coupled Plasma Atomic Emission Spectroscopy (ICP-AES). FIGS. 3A-B show the STEM images of the NiFeWBOₓ-Oleylamine catalyst at 50 nm and 20 nm.

### Example 2: Synthesis of NiFeWBOₓ-PVP OER Catalyst

11.6290 g of nickel (II) nitrate, 4.0096 g of iron (III) nitrate and 2.2546 g of tungstic acid were added into 320 ml of water. Afterwards, a 240 mL of water solution containing 5.0026 g of NaBH₄ was added to the solution containing the metal precursors under vigorous stirring where the formation of a black precipitate was observed. Subsequently. 3.0 g polyvinylpyrrolidone (PVP) (average molecular weight: 40,000) was added to the reaction system. The reaction mixture was stirred for two hours at 80° C. where the color slowly changed to green. The final material was washed with water numerous times and dried in a vacuum oven at room temperature. The chemical composition of the NiFeWBOₓ-PVP OER catalyst was determined to be Ni₄FeW_{0.13}B₃₆Oₓ via Inductively Coupled Plasma Atomic Emission Spectroscopy (ICP-AES). FIGS. 3C-D show the STEM images of the NiFeWBOₓ-PVP catalyst at 50 nm and 10 nm.

### Example 3: Intrinsic Oxygen Evolution Reaction (OER) Activity Evaluation of Two NiFeWBO-Based OER Catalysts

A commercial IrO₂ catalyst and the two NiFeWBOₓ catalysts made in Example 1 and Example 2 were evaluated in a benchtop electrochemical testing unit, in 0.1 M KOH at room temperature. The catalyst ink was prepared by mixing the catalyst and Nafion® ionomer (5 wt % in alcohol) in a mixture of deionized water and ethyl alcohol. The mixture was finely dispersed using an ultrasonication bath. An aliquot of 10 uL of the prepared ink was drop-casted on a glassy carbon working electrode. After drying in air for 20 minutes, the electrode with the drop-casted catalyst was placed in an electrochemical testing cell, along with a counter electrode made of Pt sheet and an Ag/AgCl (4M KCl) reference electrode.

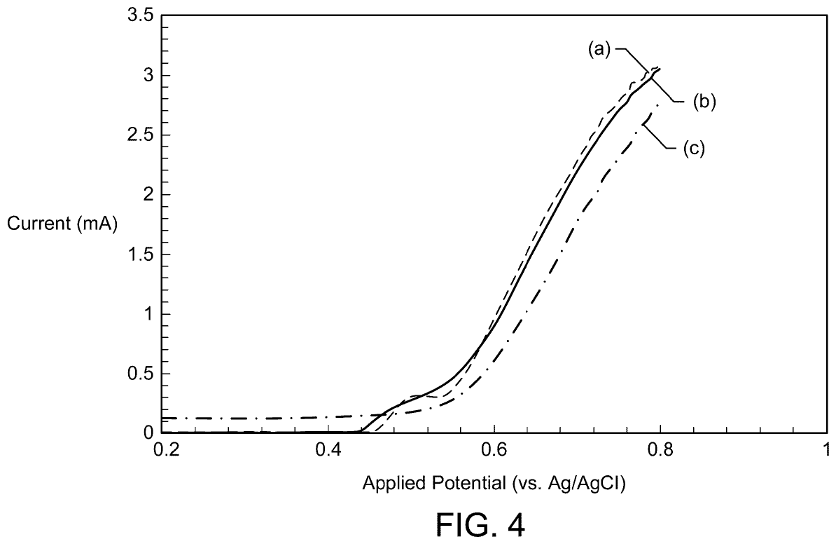

A linear sweep voltammetry (LSV) measurement in the range of 0.1 to 1 V (vs. Ag/AgCl) with a 10 mV/s rate was conducted, and the results for all three samples are shown in FIG. 4. In a LSV measurement, the current, which is a measure of oxygen evolution reaction rate, is measured when scanning the voltage applied to the working electrode, which is a measure of energy applied into the reaction. An ideal OER catalyst has as a high current at a low applied voltage, for example the catalyst can achieve 10 mA/cm² at an overpotential of 250 mA. As shown in FIG. 4, the two NiFeWBOₓ catalysts have a higher OER current at any applied cell voltage (vs. Ag/AgCl) in the measured range as compared to the commercial IrO₂ catalyst. The IrO₂ catalyst exhibits the lowest OER current at any applied cell voltage.

### Example 4: Water Electrolysis Performance Evaluation of Three OER Catalysts

The water electrolysis performance of a commercial IrO₂ catalyst and the NiFeWBOₓ catalysts made in Examples 1 and 2 were evaluated using a single water electrolysis cell at atmospheric pressure in a Scribner unit. The membrane electrode assembly (MEA) of an AEM cell comprising a 2-layer (2L) cathode hydrogen evolution reaction (HER) catalyst-coated membrane (CCM) and a 2L anode OER catalyst-coated porous transport layer (PTL). The 2L CCM cathode was prepared using an anion exchange membrane (AEM) and a Pt/C catalyst (Pt loading of 0.2 mg/cm²) as the cathode coating layer on one side of the membrane for HER. The 2L anode OER catalyst-coated PTL was prepared with a stainless steel (SS) PTL coated with the anode OER catalyst (commercial IrO₂ or NiFeWBOₓ) on one side of the PTL. The Ir loading was 1 mg/cm² whereas a higher loading of 5 mg/cm² was used for the NiFeWBOₓ catalysts. The 2L CCM was sandwiched between a carbon paper (cathode PTL) and the 2L anode OER catalyst-coated PTL to form the catalyst-coated membrane electrode assembly. The testing cell was installed using the catalyst-coated membrane electrode assembly.

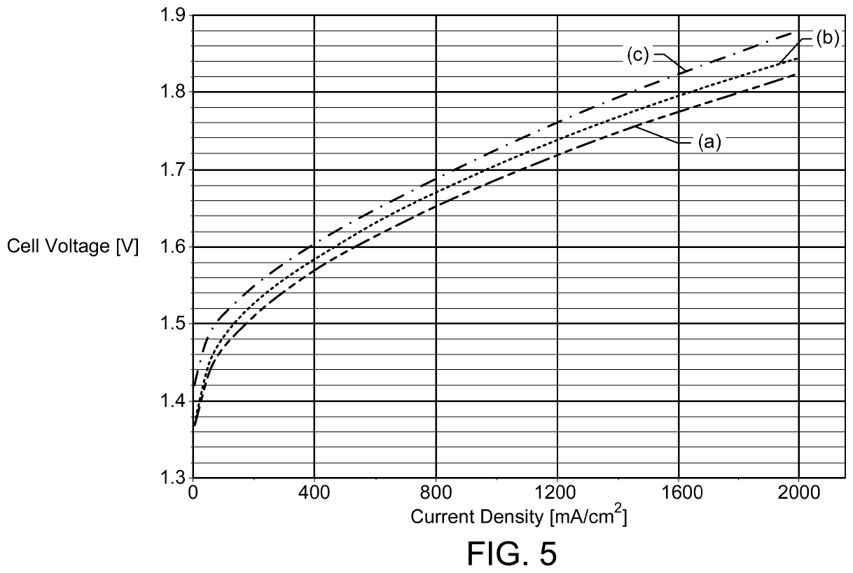

A water electrolysis test station (Scribner 600 electrolyzer test system), modified for testing with potassium hydroxide feed, was used to evaluate the water electrolysis performance of the membrane electrode assembly (MEA) comprising the commercial IrO₂ catalyst and the MEAs comprising NiFeWBOₓ catalysts in a single electrolyzer cell with an active membrane area of 5 cm². Porous transport layers (PTLs) and compression factors, defined as ratio between sealing gasket thickness and PTL thickness, were identical among these assemblies. The test station included an integrated power supply, a potentiostat, an impedance analyzer for electrochemical impedance spectroscopy (EIS) and high-frequency resistance (HFR), and real-time sensors for product flow rate and cross-over monitoring. The testing was conducted at 80° C. and 55° C., respectively under 15 psig pressure with a 1 wt % KOH feed supplied to the anode side of the test cell. The polarization curves for the MEAs comprising commercial IrO₂, NiFeWBOₓ-Oleylamine, and NiFeWBOₓ-PVP catalysts, respectively, at 80° C. are shown in FIG. 5. It can be seen from FIG. 5 that the MEAs comprising NiFeWBOₓ-Oleylamine and NiFeWBOₓ-PVP catalysts showed better performance with higher current density at the same cell voltage compared to the MEA comprising the commercial IrO₂ catalyst. This demonstrates that the hydrogen production rate for the AEM electrolyzer comprising the much lower cost NiFeWBOₓ-Oleylamine or NiFeWBOₓ-PVP catalyst is higher than the AEM electrolyzer comprising the high cost IrO₂ catalyst.

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising Ni—Fe-M-B oxyhydroxide; wherein M is a metal from Group VIB, Group VIII, and elements 57-71 of the Periodic Table, or combinations thereof; and wherein the catalyst has a layered double hydroxide structure. An embodiment of the invention is one, any or all of prior embodiments in this paragraph up through the first embodiment in this paragraph wherein M comprises tungsten, molybdenum, cobalt, cerium, or combinations thereof. An embodiment of the invention is one, any or all of prior embodiments in this paragraph up through the first embodiment in this paragraph wherein the catalyst has a formula NiₐFeM_{b}B_{c}O_{d}(OH)ₑ(H₂O)_{f} where a is in a range of 0.2 to 16; b is in a range of 0.01 to 6; c is in a range of 0.01 to 10; d is in a range of 0.01 to 30; e is in a range of 0.01 to 30; and f is in a range of 0.01 to 15. An embodiment of the invention is one, any or all of prior embodiments in this paragraph up through the first embodiment in this paragraph wherein the catalyst has a formula NiₐFeM_{b}B_{c}O_{d}(OH)ₑ(H₂O)_{f} where a is in a range of 0.5 to 8; b is in a range of 0.01 to 3; c is in a range of 0.01 to 6; d is in a range of 0.01 to 20; e is in a range of 0.01 to 20; and f is in a range of 0.01 to 10. An embodiment of the invention is one, any or all of prior embodiments in this paragraph up through the first embodiment in this paragraph wherein the catalyst comprises 0 to 60% mol Ni; 5 to 40% mol Fe; 0.01 to 30% mol M; and 0.01 to 40% mol B. An embodiment of the invention is one, any or all of prior embodiments in this paragraph up through the first embodiment in this paragraph wherein the catalyst comprises 10 to 45% mol Ni; 5 to 30% mol Fe; 0.01 to 20% mol W, Mo, Co, Ce, or combinations thereof; and 0.01 to 20% mol B. An embodiment of the invention is one, any or all of prior embodiments in this paragraph up through the first embodiment in this paragraph wherein the catalyst has a BET surface area of greater than or equal to 50 m²/g and a layered structure with a catalyst layer thickness of less than or equal to 200 nm. An embodiment of the invention is one, any or all of prior embodiments in this paragraph up through the first embodiment in this paragraph wherein the catalyst has a BET surface area of greater than or equal to 100 m²/g and a layered structure with a catalyst layer thickness of less than or equal to 100 nm. An embodiment of the invention is one, any or all of prior embodiments in this paragraph up through the first embodiment in this paragraph wherein the catalyst is insoluble in water or alkaline aqueous solution with a pH of greater than or equal to 7.5. An embodiment of the invention is one, any or all of prior embodiments in this paragraph up through the first embodiment in this paragraph wherein the catalyst is coated on one surface of an anion exchange membrane or on one surface of a porous transport material.

A second embodiment of the invention is a method of making a non-platinum group metal (non-PGM) catalyst for oxygen evolution reaction (OER) for water electrolysis comprising mixing a Ni precursor, an Fe precursor, and a M precursor in a solvent; adding an exfoliating reagent; adding NaBH₄; heating the mixture; and precipitating and washing the catalyst; wherein M is a metal from Groups VIB or VIII, or elements 57-71 of the Periodic Table. or combinations thereof; and wherein the catalyst has a layered double hydroxide structure. An embodiment of the invention is one, any or all of prior embodiments in this paragraph up through the second embodiment in this paragraph wherein the catalyst has a BET surface area of greater than or equal to 50 m²/g and exhibiting a layered structure with a catalyst layer thickness of less than or equal to 200 nm. An embodiment of the invention is one, any or all of prior embodiments in this paragraph up through the second embodiment in this paragraph wherein the catalyst has a BET surface area of greater than or equal to 100 m²/g and exhibiting a layered structure with a catalyst layer thickness of less than or equal to 100 nm. An embodiment of the invention is one, any or all of prior embodiments in this paragraph up through the second embodiment in this paragraph wherein M comprises W. Mo. Co. Ce. or combinations thereof. An embodiment of the invention is one, any or all of prior embodiments in this paragraph up through the second embodiment in this paragraph wherein the catalyst has a formula NiₐFeM_{b}B_{c}O_{d}(OH)ₑ(H₂O)_{f} where a is in a range of 0.2 to 16; b is in a range of 0.01 to 6; c is in a range of 0.01 to 10; d is in a range of 0.01 to 30; e is in a range of 0.01 to 30; and f is in a range of 0.01 to 15. An embodiment of the invention is one, any or all of prior embodiments in this paragraph up through the second embodiment in this paragraph wherein the catalyst has a formula NiₐFeM_{b}B_{c}O_{d}(OH)ₑ(H₂O)_{f} where a is in a range of 0.5 to 8; b is in a range of 0.01 to 3; c is in a range of 0.01 to 6; d is in a range of 0.01 to 20; e is in a range of 0.01 to 20; and f is in a range of 0.01 to 10. An embodiment of the invention is one, any or all of prior embodiments in this paragraph up through the second embodiment in this paragraph wherein the catalyst comprises 10 to 60% mol Ni; 5 to 40% mol Fe; 0.01 to 30% mol M; and 0.01 to 40% mol B. An embodiment of the invention is one, any or all of prior embodiments in this paragraph up through the second embodiment in this paragraph wherein the catalyst comprises 10 to 45% mol Ni; 5 to 30% mol Fe; 0.01 to 20% mol Mo. Co. Ce. or combinations thereof; and 0.01 to 20% mol B. An embodiment of the invention is one, any or all of prior embodiments in this paragraph up through the second embodiment in this paragraph wherein the exfoliating reagent comprises butylamine, trimethylamine, triethanolamine, triphenylphosphine, oleylamine, polyvinylpyrrolidone, or combinations thereof. An embodiment of the invention is one, any or all of prior embodiments in this paragraph up through the second embodiment in this paragraph wherein the solvent comprises water, alcohol, acetonitrile, N, N-dimethylformamide, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A non-platinum group metal (non-PGM) catalyst for oxygen evolution reaction (OER) for water electrolysis comprising:
Ni—Fe-M-B oxyhydroxide;
wherein M is a metal from Group VIB, Group VIII, and elements 57-71 of the Periodic Table, or combinations thereof; and
wherein the catalyst has a layered double hydroxide structure.

2. The catalyst of claim 1 wherein M comprises tungsten, molybdenum, cobalt, cerium, or combinations thereof.

3. The catalyst of claim 1 wherein the catalyst has a formula:
NiₐFeM_{b}B_{c}O_{d}(OH)ₑ(H₂O)_{f}
where a is in a range of 0.2 to 16; b is in a range of 0.01 to 6; c is in a range of 0.01 to 10; d is in a range of 0.01 to 30; e is in a range of 0.01 to 30; and f is in a range of 0.01 to 15.

4. The catalyst of claim 1 wherein the catalyst has a formula:
NiₐFeM_{b}B_{c}O_{d}(OH)ₑ(H₂O)_{f}
where a is in a range of 0.5 to 8; b is in a range of 0.01 to 3; c is in a range of 0.01 to 6; d is in a range of 0.01 to 20; e is in a range of 0.01 to 20; and f is in a range of 0.01 to 10.

5. The catalyst of claim 1 wherein the catalyst comprises:
10 to 60% mol Ni;
5 to 40% mol Fe;
0.01 to 30% mol M; and
0.01 to 40% mol B.

6. The catalyst of claim 1 wherein the catalyst comprises:
10 to 45% mol Ni;
5 to 30% mol Fe;
0.01 to 20% mol W, Mo, Co, Ce, or combinations thereof; and
0.01 to 20% mol B.

7. The catalyst of claim 1 wherein the catalyst has a BET surface area of greater than or equal to 50 m²/g and a layered structure with a catalyst layer thickness of less than or equal to 200 nm.

8. The catalyst of claim 1 wherein the catalyst has a BET surface area of greater than or equal to 100 m²/g and a layered structure with a catalyst layer thickness of less than or equal to 100 nm.

9. The catalyst of claim 1 wherein the catalyst is insoluble in water or alkaline aqueous solution with a pH of greater than or equal to 7.5.

10. The catalyst of claim 1 wherein the catalyst is coated on one surface of an anion exchange membrane or on one surface of a porous transport material.

11. A method of making a non-platinum group metal (non-PGM) catalyst for oxygen evolution reaction (OER) for water electrolysis comprising:
mixing a Ni precursor, an Fe precursor, and a M precursor in a solvent;
adding an exfoliating reagent;
adding NaBH₄;
heating the mixture; and
precipitating and washing the catalyst;
wherein M is a metal from Groups VIB or VIII, or elements 57-71 of the Periodic Table, or combinations thereof; and
wherein the catalyst has a layered double hydroxide structure.

12. The method of claim 11 wherein the catalyst has a BET surface area of greater than or equal to 50 m²/g and exhibiting a layered structure with a catalyst layer thickness of less than or equal to 200 nm.

13. The method of claim 11 wherein the catalyst has a BET surface area of greater than or equal to 100 m²/g and exhibiting a layered structure with a catalyst layer thickness of less than or equal to 100 nm.

14. The method of claim 11 wherein M comprises W, Mo, Co, Ce, or combinations thereof.

15. The method of claim 11 wherein the catalyst has a formula:
NiₐFeM_{b}B_{c}O_{d}(OH)ₑ(H₂O)_{f}
where a is in a range of 0.2 to 16; b is in a range of 0.01 to 6; c is in a range of 0.01 to 10; d is in a range of 0.01 to 30; e is in a range of 0.01 to 30; and f is in a range of 0.01 to 15.

16. The method of claim 11 wherein the catalyst has a formula:
NiₐFeM_{b}B_{c}O_{d}(OH)ₑ(H₂O)_{f}
where a is in a range of 0.5 to 8; b is in a range of 0.01 to 3; c is in a range of 0.01 to 6; d is in a range of 0.01 to 20; e is in a range of 0.01 to 230; and f is in a range of 0.01 to 10.

17. The method of claim 11 wherein the catalyst comprises:
10 to 60% mol Ni;
5 to 40% mol Fe;
0.01 to 30% mol M; and
0.01 to 40% mol B.

18. The method of claim 11 wherein the catalyst comprises:
10 to 45% mol Ni;
5 to 30% mol Fe;
0.01 to 20% mol Mo, Co, Ce, or combinations thereof; and
0.01 to 20% mol B.

19. The method of claim 11 wherein the exfoliating reagent comprises butylamine, trimethylamine, triethanolamine, triphenylphosphine, oleylamine, polyvinylpyrrolidone, or combinations thereof.

20. The method of claim 11 wherein the solvent comprises water, alcohol, acetonitrile, N, N-dimethylformamide, or combinations thereof.
